(19) United States
(12) Patent Application Publication
(10) Pub. No.: US 2008/0065750 A1
(43) Pub. Date: Mar. 13, 2008

(54) LOCATION AND MANAGEMENT OF COMPONENTS ACROSS AN ENTERPRISE USING REUSABLE ASSET SPECIFICATION

(76) Inventors: Margaret M. O'Connell, Allston, MA (US); Justin J. Grunau, Somerville, MA (US); Hanna Russo, Newton, MA (US); Asima Silva, Holden, MA (US)

Correspondence Address: HOFFMAN, WARNICK & D'ALESSANDRO LLC, 75 STATE ST, 14TH FLOOR, ALBANY, NY, 12207, US

(21) Appl. No.: 11/530,141

(22) Filed: Sep. 8, 2006

(51) Int. Cl. G06F 15/173; G06F 15/16

(52) U.S. Cl. 709/223; 709/236

(57) ABSTRACT

The present invention provides relates to the location and management of components in a unified manner across an enterprise using the Reusable Asset Specification (RAS). A method for locating components across an enterprise in accordance with an embodiment of the present invention includes: generating a RAS asset for each of a plurality of components; registering each of the RAS assets on at least one RAS repository, the registering providing meta-data for each of the plurality of components; and locating a component using the meta-data provided in the RAS repositories during the registration process.

### CROSS-REFERENCE TO RELATED APPLICATIONS

This patent application is related in some aspects to U.S. patent application Ser. No. 11/321,857, filed on Dec. 29, 2005, entitled “Virtual RAS Repository,” incorporated herein by reference, and U.S. patent application Ser. No. 11/321,542, filed on Dec. 29, 2005, entitled “Use of a RAS Profile to Integrate an Application into a Templatable Solution,” incorporated herein by reference.

### FIELD OF THE INVENTION

The present invention generally relates to software applications, and more specifically relates to the location and management of components in a unified manner across an enterprise using the Reusable Asset Specification.

### BACKGROUND OF THE INVENTION

In companies today, there are many components that are distributed across networks, platforms, databases, etc. Examples of such components include services (e.g., web services and Enterprise Java Beans (EJBs)), portlets, and plug-ins (Java and all Java-based trademarks are trademarks of Sun Microsystems, Inc. in the United States, other countries, or both). The components can include both non-deployed and deployed software artifacts. Locating and managing such distributed components can be a difficult task.

A scenario illustrating this problem is depicted in FIG. 1. In this scenario, an enterprise 10 includes several geographically distinct sites 12, including in the US, China, and India, providing services S1, S2, S3, . . . , S7. The services are located on servers 14 provided by different vendors, V1, V2, V3. Application A is provided in the US site 12 on a server 14 provided by vendor V1 using the services S1, S4, S5, S7, Application B is provided in the China site 12 on a server 14 provided by vendor V2 using the services S2, S1, S5, S6, and Application C is provided in the India site 12 on a server 14 provided by vendor V3 using the services S3, S1, S5. In some cases, the service deployment is duplicated across the enterprise (services S1 and S5 are shared by the US, China, and India sites 12). Disadvantages of this approach include, for example, redundancy, increased setup costs, inefficient use and increased cost of storage space, and updating/versioning related issues.

### SUMMARY OF THE INVENTION

The present invention relates to the location and management of components in a unified manner across an enterprise using the Reusable Asset Specification.

A first aspect of the present invention is directed to a method for locating components across an enterprise, comprising: generating a Reusable Asset Specification (RAS) asset for each of a plurality of components; registering each of the RAS assets on at least one RAS repository, the registering providing meta-data for each of the plurality of components; and locating a component using the meta-data provided in the RAS repositories during the registration process.

A second aspect of the present invention is directed to a system for locating components across an enterprise, comprising: a system for generating a Reusable Asset Specification (RAS) asset for each of a plurality of components; a system for registering each of the RAS assets on at least one RAS repository, the registering providing meta-data for each of the plurality of components; and a system for locating a component using the meta-data provided in the RAS repositories during the registration process.

A third aspect of the present invention is directed to a program product stored on a computer readable medium for locating components across an enterprise, the computer readable medium comprising program code for: generating a Reusable Asset Specification (RAS) asset for each of a plurality of components; registering each of the RAS assets on at least one RAS repository, the registering providing meta-data for each of the plurality of components; and locating a component using the meta-data provided in the RAS repositories during the registration process.

A fourth aspect of the present invention is directed to a method for deploying an application for locating components across an enterprise, comprising: providing a computer infrastructure being operable to: generate a Reusable Asset Specification (RAS) asset for each of a plurality of components; register each of the RAS assets on at least one RAS repository, the registering providing meta-data for each of the plurality of components; and locate a component using the meta-data provided in the RAS repositories during the registration process.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative scenario involving an enterprise in accordance with the prior art.

FIG. 2 depicts a flow diagram of an illustrative process in accordance with an embodiment of the present invention

FIG. 3 depicts an illustrative XML schema for a RAS asset.

FIG. 4 depicts an illustrative scenario involving an enterprise in accordance with an embodiment of the present invention.

FIG. 5 depicts an illustrative computer system for implementing embodiment(s) of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

The Reusable Asset Specification (RAS) defines a standard way to describe, organize, package, and manage different types of reusable software assets. A reusable software asset is, broadly speaking, any cohesive collection of artifacts that solve a specific problem or set of problems encountered in the software development life cycle. A reusable software asset is created with the intent of reuse. A reusable asset is distinguished from other artifacts or collections of artifacts used in the software development life cycle by its packaging. A reusable asset's packaging is simply the set of files that implement the solution and a structured set of meta information that defines and describes the reusable asset as a whole.

In the following description of the present invention, it is assumed that the reader has an understanding of RAS. Accordingly, a detailed description of RAS is not included herein. Additional information regarding RAS can be found, for example, at: www.omg.org/technology/documents/formal/ras.htm.

As detailed above, RAS standardizes the way to organize, package, and manage distributed reusable assets. The present invention extends this concept by using RAS to search, discover, and manage components of many different types of containers, residing in any location, in a unified manner across an enterprise.

The present invention organizes an enterprise's components in a way that is not disruptive, without requiring the components to be copied or moved. This is useful because, in many cases, components are quite complex and difficult to relocate and consolidate. Indeed, components can reside at any location, such as inside a content management system, version control system, database, file system, etc.

A flow diagram 20 of an illustrative process in accordance with an embodiment of the present invention is depicted in FIG. 2. In step S1, a RAS wrapper is generated for each component (e.g., service), creating a RAS asset. This can be done, for example, using a manual registry or via an automatic discovery process and registration. The resulting RAS assets include, for instance, identification, classification, and other meta-data that can be used to locate and manage the RAS assets.

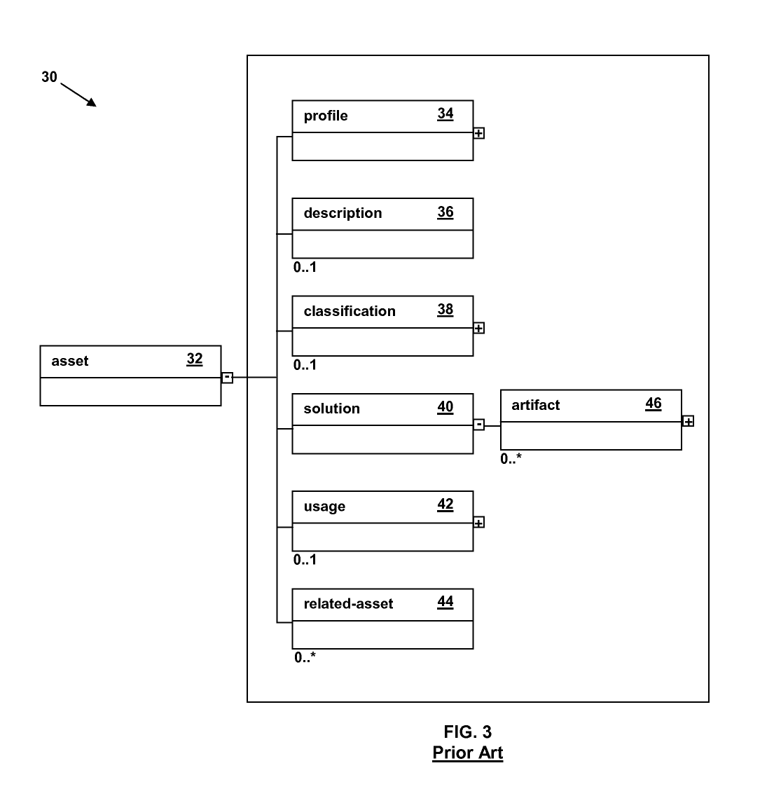

An illustrative extensible Markup Language (XML) schema 30 for a RAS asset 32 is depicted in FIG. 3. The RAS asset 32 includes a plurality of classes including profile 34, description 36, classification 38, solution 40, usage 42, and related-asset 44. The profile 34 identifies the particular type of RAS asset 32 being described. The description 36 provides a textual description/summary of the RAS asset 32. The classification 38 contains descriptors which classify the key characteristics and behaviors of the RAS asset 32. The solution 40 contains references to the artifact(s) 46 included in the RAS asset 32. The usage 42 provides information regarding how to apply/use the asset RAS 32. The related-asset 44 describes the relationships (if any) between the asset RAS 32 and other RAS assets. Each artifact 46 can include a plurality of classes (not shown), including variability-point, description, artifact-context, artifact-dependency, artifact-type, and artifact.

Returning again to the flow diagram 20 depicted in FIG. 2, a plurality of RAS repositories are provided in step S2. In step S3, each RAS asset created in step S1 is registered in one or more of the RAS repositories for location and management purposes. The registration includes storing meta-data (e.g., instance, identification, classification, etc.) corresponding to each registered RAS asset in the associated RAS repository. In step S4, component(s) (e.g., services) can be located by searching the meta-data provided in the RAS repositories.

In accordance with the present invention, an enterprise's services, in the form of RAS assets, are registered in a plurality of RAS repositories. By providing the services in the form of RAS assets, the services are normalized into a form that can be searched and located using any suitable search methodology. Suitable search methodologies can include, for example, Java Naming and Directory Interface (JNDI), Lightweight Directory Access Protocol (LDAP), Universal Description Discovery and Integration (UDDI), etc.

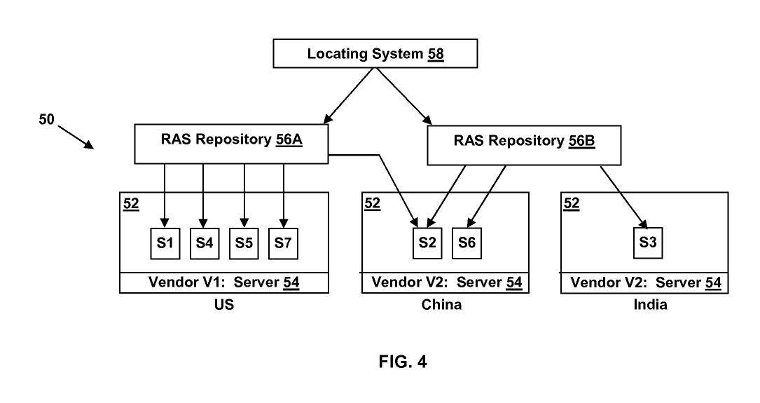

An illustrative scenario in accordance with an embodiment of the present invention is depicted in FIG. 4. In this scenario, an enterprise 50 includes several geographically distinct sites 52, including in the US, China, and India, providing services S1, S2, S3, . . . , S7. The services S1, S2, S3, . . . , S7 are located on servers 54 provided by different vendors, V1, V2, V3.

The enterprise 50 further includes a plurality of RAS repositories 56A, 56B. The RAS asset corresponding to each service S1, S2, S3, . . . , S7 is registered in one or more of the plurality of RAS repositories 56A, 56B. In this scenario, for example, the RAS assets corresponding to the services S1, S4, S5, S7, provided on the server 54 located in the US site 52, are registered with the RAS repository 56A. To this extent, meta-data associated with the RAS assets corresponding to the services S1, S4, S5, S7 is available on the RAS repository 56A. Similarly, the RAS assets corresponding to the services S2, S6, provided on the server 54 located in the China site 52, and the RAS asset corresponding to the service S3 provided on the server 54 located in the India site 52, are registered with the RAS repository 56B. Thus, meta-data associated with the RAS assets corresponding to the services S2, S6 is available on the RAS repository 56B. The RAS asset corresponding to the service S2 is also registered in the RAS repository 56A.

A locating system 58 is provided to locate the services S1, S2, S3, . . . S7 on the servers 54 using the meta-data associated with the corresponding RAS assets provided on the RAS repositories 56A, 56B. As detailed above, any suitable search methodology, such as JNDI, LDAP, UDDI, etc., can be used by the locating system 58 to locate desired services. To locate a given service S1, S2, S3, . . . , S7 on the servers 54, the locating system 58 accesses and searches through the meta-data provided on the RAS repositories 56A, 56B. For example, to deploy Application B comprising the services S2, S1, S5, S6, the locating system 58 accesses and searches through the meta-data of the RAS assets provided on the RAS repositories 56A, 56B. In doing so, the locating system 58 determines that the services S1, S5 are located on the server 54 in the US site 52, while the services S2, S6 are located on the server 54 in the China site 52.

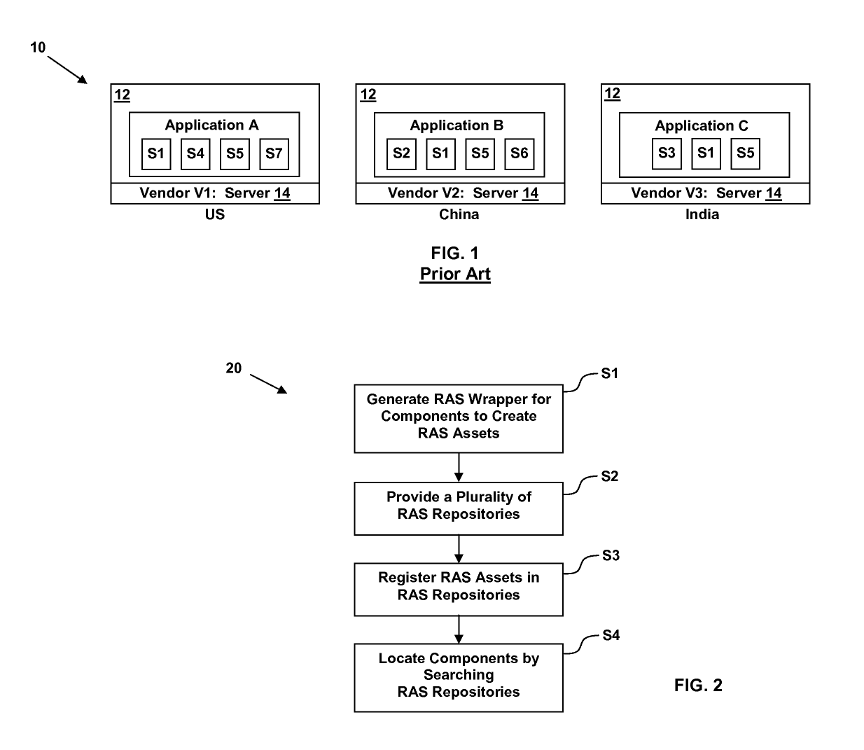

In accordance with the present invention, as depicted, for example, in FIG. 4, it can be seen that each service S1, S2, S3, . . . , S7 is stored in one location. As such, unlike in the scenario depicted in FIG. 1, there is no redundancy of services across locations. This saves storage space, prevents version clashes, and provides consistency when finding and using the services.

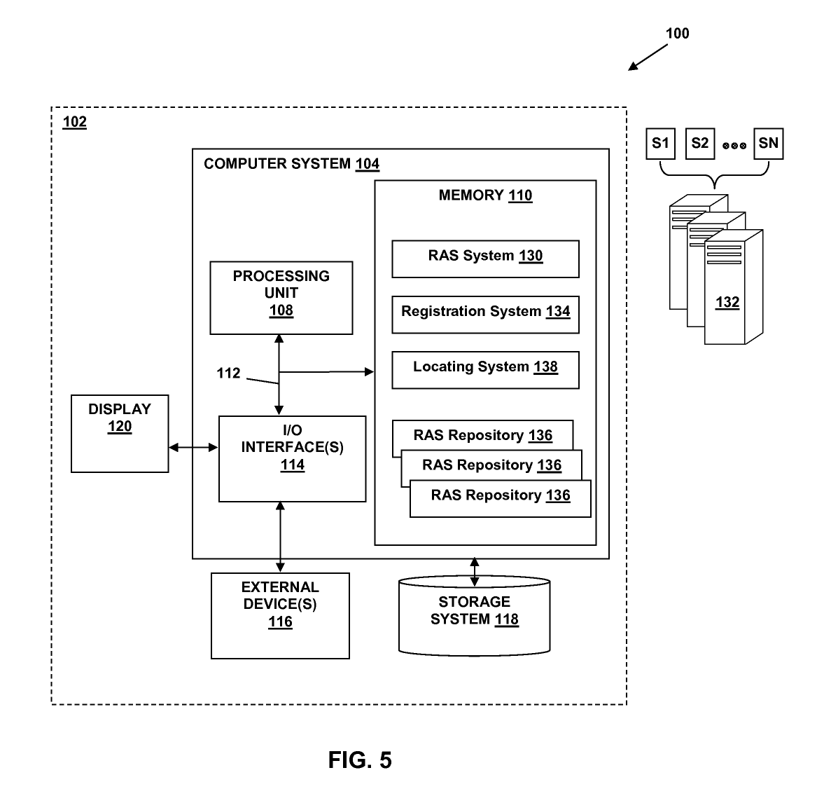

FIG. 5 depicts an illustrative system 100 in accordance with embodiment(s) of the present invention. The system 100 includes a computer infrastructure 102 that can perform the various process steps described herein. The computer infrastructure 102 is shown including a computer system 104.

The computer system 104 is shown as including a processing unit 108, a memory 110, at least one input/output (I/O) interface 114, and a bus 112. Further, the computer system 104 is shown in communication with at least one external device 116 and a storage system 118. In general, the processing unit 108 executes computer program code that is stored in memory 110 and/or storage system 118. While executing computer program code, the processing unit 108 can read and/or write data from/to the memory 110, storage system 118, and/or I/O interface(s) 114. Bus 112 provides a communication link between each of the components in the computer system 104. The external device(s) 116 can comprise any device (e.g., display 120) that enables a user (not shown) to interact with the computer system 104 or any device that enables the computer system 104 to communicate with one or more other computer systems.

In accordance with an embodiment of the present invention, the program code stored in the memory 110 comprises a RAS system 130 for generating a RAS asset for each of a plurality of services S1, S2, . . . , SN, located on a plurality of servers 132. Also provided is a registration system 134 for registering each of the RAS assets on one or more RAS repositories 136, and a locating system 138 for locating the services S1, S2, . . . , SN using meta-data provided in the RAS repositories 136 during the registration process. The operation carried out by each of these systems is described in greater detail above.

The computer system 104 can comprise any general purpose computing article of manufacture capable of executing computer program code installed by a user (e.g., a personal computer, server, handheld device, etc.). However, it is understood that the computer system 104 and the is only representative of various possible computer systems that may perform the various process steps of the invention. To this extent, in other embodiments, the computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, the computer infrastructure 102 is only illustrative of various types of computer infrastructures that can be used to implement the present invention. For example, in one embodiment, the computer infrastructure 102 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

It is understood that some of the various systems shown in FIG. 5 can be implemented independently, combined, and/or stored in memory for one or more separate computer systems that communicate over a network. Further, it is understood that some of the systems and/or functionality may not be implemented, or additional systems and/or functionality may be included as part of the system 100.

It is understood that the invention further provides various alternative embodiments. For example, in one embodiment, the invention provides a computer-readable medium that includes computer program code to enable a computer infrastructure to carry out and/or implement the various process steps of the present invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as the memory 110 and/or storage system 118 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. A service provider can create, maintain, support, etc., a computer infrastructure, such as the computer infrastructure 102, that performs the process steps of the invention for one or more customers. In return, the service provider can receive payment from the customer(s) under a subscription and/or fee agreement and/or the service provider can receive payment from the sale of advertising space to one or more third parties.

In still another embodiment, a computer infrastructure, such as the computer infrastructure 102, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as the computer system 104, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of the preferred embodiments of this invention has been presented for purposes of illustration and description. It is not intended to be exhaustive or to limit the invention to the precise form disclosed, and obviously, many modifications and variations are possible.

What is claimed is:

1. A method for locating components across an enterprise, comprising:
generating a Reusable Asset Specification (RAS) asset for each of a plurality of components;
registering each of the RAS assets on at least one RAS repository, the registering providing meta-data for each of the plurality of components; and
locating a component using the meta-data provided in the RAS repositories during the registration process.

2. The method of claim 1, wherein registering each of the RAS assets further comprises:
storing the meta-data corresponding to each registered RAS asset in each RAS repository in which the RAS asset is registered.

3. The method of claim 1, wherein the plurality of components are located in geographically distinct sites.

4. The method of claim 1, wherein the RAS assets corresponding to the plurality of components can be registered in any of the RAS repositories.

5. The method of claim 1, wherein locating a component using the meta-data further comprises:
searching the meta-data provided in the RAS repositories to locate a component.

6. The method of claim 1, wherein each of the plurality of components is stored in one location.

7. A system for locating components across an enterprise, comprising:
a system for generating a Reusable Asset Specification (RAS) asset for each of a plurality of components;
a system for registering each of the RAS assets on at least one RAS repository, the registering providing meta-data for each of the plurality of components; and
a system for locating a component using the meta-data provided in the RAS repositories during the registration process.

8. The system of claim 7, wherein the system for registering each of the RAS assets further comprises:
a system for storing the meta-data corresponding to each registered RAS asset in each RAS repository in which the RAS asset is registered.

9. The system of claim 7, wherein the plurality of components are located in geographically distinct sites.

10. The system of claim 7, wherein the RAS assets corresponding to the plurality of components can be registered in any of the RAS repositories.

11. The system of claim 7, wherein the system for locating a component using the meta-data further comprises:
a system for searching the meta-data provided in the RAS repositories to locate a component.

12. The system of claim 7, wherein each of the plurality of components is stored in one location.

13. A program product stored on a computer readable medium for locating components across an enterprise, the computer readable medium comprising program code for:
generating a Reusable Asset Specification (RAS) asset for each of a plurality of components;
registering each of the RAS assets on at least one RAS repository, the registering providing meta-data for each of the plurality of components; and
locating a component using the meta-data provided in the RAS repositories during the registration process.

14. The program product of claim 13, wherein the program code for registering each of the RAS assets further comprises:
program code for storing the meta-data corresponding to each registered RAS asset in each RAS repository in which the RAS asset is registered.

15. The program product of claim 13, wherein the plurality of components are located in geographically distinct sites.

16. The program product of claim 13, wherein the RAS assets corresponding to the plurality of components can be registered in any of the RAS repositories.

17. The program product of claim 13, wherein the program code for locating a component using the meta-data further comprises:
program code for searching the meta-data provided in the RAS repositories to locate a component.

18. The program product of claim 13, wherein each of the plurality of components is stored in one location.
